(19) United States
(12) Patent Application Publication
(10) Pub. No.: US 2013/0034766 A1
(43) Pub. Date: Feb. 7, 2013

(54) SEPARATOR FOR REDOX FLOW BATTERY AND REDOX FLOW BATTERY INCLUDING SAME

(71) Applicant: Hee-Tak Kim, Yongin-si (KR)

(72) Inventor: Hee-Tak Kim, Yongin-si (KR)

(21) Appl. No.: 13/472,223

(22) Filed: May 15, 2012

(30) Foreign Application Priority Data
Aug. 2, 2011 (KR) 10-2011-0077107

(51) Int. Cl. H01M 4/36; H01M 2/16

(52) U.S. Cl. 429/105; 429/249

(57) ABSTRACT

A separator for a redox flow battery including a proton conductive polymer including a first repeating unit represented by the following Chemical Formula 1a and a second repeating unit represented by the following Chemical Formula 1b, and a redox flow battery including the same.

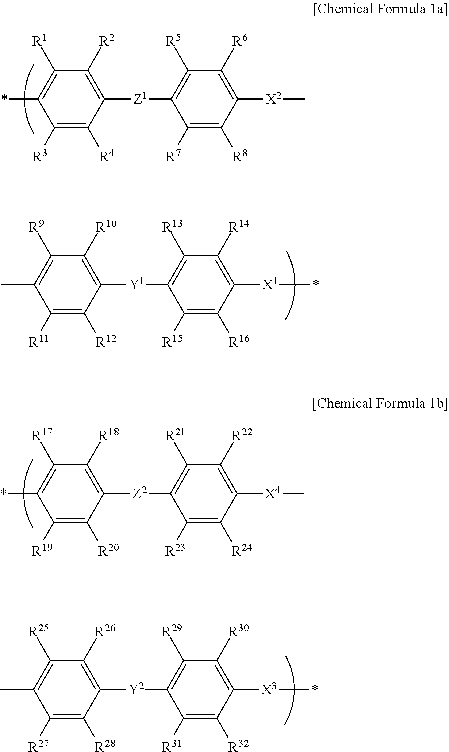

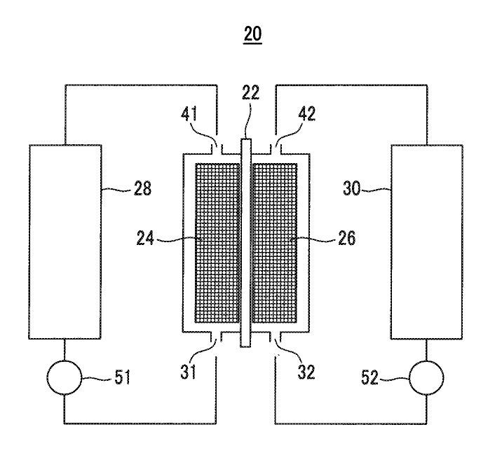

In Chemical Formulas 1a and 1b, each substituent is the same as defined in the detailed description.

### CROSS-REFERENCE TO RELATED APPLICATION

This application claims priority to and the benefit of Korean Patent Application No. 10-2011-0077107, filed in the Korean Intellectual Property Office on Aug. 2, 2011, the entire content of which is incorporated herein by reference.

### BACKGROUND

1. Field

This disclosure relates to a separator for a redox flow battery and a redox flow battery including the same.

2. Description of Related Art

A rechargeable battery having light weight, and for transforming electrical energy into chemical energy, storing the chemical energy, and then retransforming the chemical energy into electrical energy, has been actively researched. Recently, a redox flow battery, which is a kind of rechargeable battery, has drawn attention as a high-capacity and high efficiency rechargeable battery appropriate for a big-sized system such as electric power storage and the like. The redox flow battery uses a positive active material and a negative active material as an aqueous solution. When the positive active material solution and the negative active material solution are supplied to an electrode assembly including a positive electrode, a negative electrode, and a separator, each ion is oxidized/reduced at the positive and negative electrodes and generates electrical energy. On the other hand, the separator should transmit protons and block positive ions of positive and negative active materials from moving to a counter electrode (i.e. negative electrode and positive electrode), but occasionally transmits cations, particularly vanadium cations, and thus causes a self discharge problem.

### SUMMARY

An aspect of an exemplary embodiment of the present invention is directed toward a separator for a redox flow battery suppressing self discharge and improving coulombic efficiency.

Another aspect of an embodiment of the present invention is directed toward a redox flow battery including the separator.

According to one embodiment of the present invention, provided is a separator for a redox flow battery including a proton conductive polymer including a first repeating unit represented by the following Chemical Formula 1a and a second repeating unit represented by the following Chemical Formula 1b.

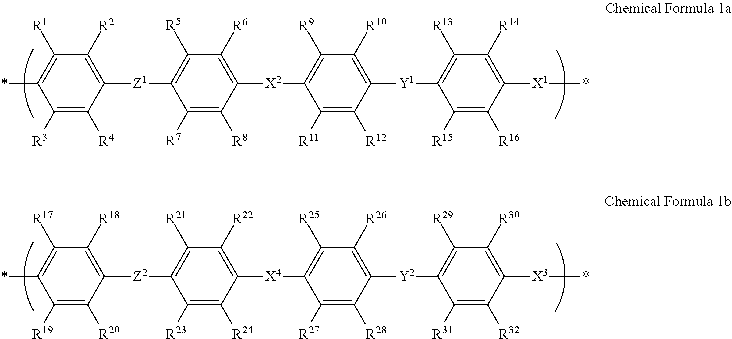

In Chemical Formulas 1a and 1b,

X¹, X², X³ and X⁴ are the same or different and are each O or S,

Y¹ and Y² are the same or different and are each SO₂ or C(CF₂)₂,

Z¹ and Z² are the same or different and are each SO₂ or CO,

R¹ to R¹⁶ are the same or different and are each hydrogen, a halogen, a C1 to C10 alkyl group, a C1 to C10 halogen-substituted alkyl group, a sulfonic acid group, a phosphoric acid group, or a carboxylic acid group, provided that at least one of R¹ to R¹⁶ is a sulfonic acid group, a phosphoric acid group, or a carboxylic acid group,

R¹⁷ to R³² are the same or different and are each hydrogen, a halogen, a C1 to C10 alkyl group, or a C1 to C10 halogen-substituted alkyl group,

a mole fraction (n) of the first repeating unit represented by Chemical Formula 1a, is 0.3≦n≦0.8 based on the total moles of the first and the second repeating unit, and

a mole fraction (m) of the second unit represented by Chemical Formula 1b is 0.2≦m≦0.7 based on the total moles of the first and the second repeating unit.

In the above Chemical Formulas 1a and 1b, at least one of R¹ to R⁴ and at least one of R⁵ to R⁸ may be each a sulfonic acid group, a phosphoric acid group, or a carboxylic acid group.

According to one embodiment, a mole fraction (n) of the first repeating unit represented by Chemical Formula 1a, is 0.4≦n≦0.7 based on the total moles of the first and the second repeating unit and a mole fraction (m) of the second unit represented by Chemical Formula 1b is 0.3≦m≦0.6 based on the total moles of the first and the second repeating unit.

The separator may have a thickness in a range from 10 μm to 200 μm.

According to another embodiment of the present invention, provided is a redox flow battery including an electrode assembly including the above separator, a positive electrode, and a negative electrode, the separator being between the positive electrode and the negative electrode; a positive electrode supplier including a positive active material solution and configured to supply the positive active material solution to the positive electrode; and a negative electrode supplier including a negative active material solution and configured to supply the negative active material solution to the negative electrode.

The positive active material solution may include a positive active material and a solvent.

The positive active material may include a +4 to +5 vanadium-based compound and specifically (VO₂)₂SO₄, VO(SO₄), or a combination thereof.

The solvent may include a sulfuric acid aqueous solution.

The positive active material solution may have a concentration in a range from 1M to 10M.

The negative active material solution may include a negative active material and a solvent.

The negative active material may include a +2 to +3 vanadium-based compound and specifically, VSO₄, V₂(SO₄)₃, or a combination thereof.

The solvent may include a sulfuric acid aqueous solution.

The negative active material solution may have a concentration in a range from 1M to 10M.

Hereinafter, further embodiments will be described in the detailed description in more detail.

An embodiment of the present invention provides a separator for a redox flow battery capable of suppressing self discharge and improving coulombic efficiency, and thus realizes a redox flow battery with high energy efficiency.

### BRIEF DESCRIPTION OF THE DRAWING

The drawing is a schematic view illustrating a redox flow battery according to one embodiment.

### DETAILED DESCRIPTION

Exemplary embodiments of the present disclosure will hereinafter be described in detail. However, these embodiments are only exemplary, and this disclosure is not limited thereto.

According to one embodiment of the present invention, a separator for a redox flow battery is formed of a proton conductive polymer.

The proton conductive polymer may specifically include a first repeating unit represented by the following Chemical Formula 1a and a second repeating unit represented by the following Chemical Formula 1b. The proton conductive polymer may be any copolymer without limitation for the kind and number of a repeating unit, for example, a block copolymer including regularly repeated repeating units or a random copolymer including randomly repeated repeating units.

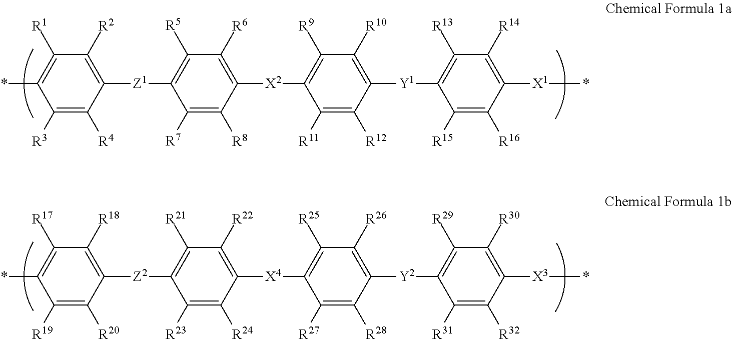

In Chemical Formulas 1a and 1b, as shown above, the proton conductive polymer may have a main chain structure respectively including four benzene rings in the first and the second repeating units.

In the above Chemical Formulas 1a and 1b, X¹, X², X³, and X⁴ are the same or different and are each O or S.

Y¹ and Y² are the same or different and are each SO₂ or C(CF₂)₂.

Z¹ and Z² are the same or different and are each SO₂ or CO.

R¹ to R¹⁶ are the same or different and are each hydrogen, a halogen, a C1 to C10 alkyl group, a C1 to C10 halogen-substituted alkyl group, a sulfonic acid group, a phosphoric acid group, or a carboxylic acid group, provided that at least one of R¹ to R16 is a sulfonic acid group, a phosphoric acid group, or a carboxylic acid group. Specifically, at least one of R¹ to R⁴ and at least one of R⁵ to R⁵ may be each a sulfonic acid group, a phosphoric acid group, or a carboxylic acid group.

The first repeating unit includes a hydrophilic group such as the sulfonic acid group, the phosphoric acid group, or the carboxylic acid group and may be classified to be hydrophilic.

R¹⁷ to R³² are the same or different and are each hydrogen atom, halogen atom, a C1 to C10 alkyl group, or a C1 to C10 halogen-substituted alkyl group.

The second repeating unit includes no hydrophilic group such as the sulfonic acid group, the phosphoric acid group, or the carboxylic acid group, but a hydrophobic group such as the hydrogen atom, halogen atom, C1 to C10 alkyl group, or C1 to C10 halogen-substituted alkyl group, and thus may be classified to be hydrophobic.

In this way, the proton conductive polymer may include hydrophilic and hydrophobic groups.

The halogen atom may be specifically a fluorine atom.

The C1 to C10 halogen-substituted alkyl group may specifically include a C1 to C10 fluorine substituted alkyl group, in more particular, a C1 to C10 trifluoroalkyl group, and in even more particular, a trifluoromethyl group.

In Chemical Formulas 1a and 1b, a mole fraction (n) of the first repeating unit represented by Chemical Formula 1a, is 0.3≦n≦0.8 based on the total moles of the first and the second repeating unit and a mole fraction (m) of the second unit represented by Chemical Formula 1b is 0.2≦m≦0.7 based on the total moles of the first and the second repeating unit, and specifically, 0.4≦n≦0.7, and 0.3≦m≦0.6. In one embodiment, when the hydrophilic and hydrophobic groups are included within the above ratio range, the vanadium-based active material of positive and negative electrodes is not only effectively suppressed from cross-over to a counter electrode, but proton conductivity is also improved.

Specifically, hydrophilic and hydrophobic groups may have a slight phase separation due to structural repulsion between the two groups. Herein, the phase separation may have a very fine domain size because the hydrophilic and hydrophobic groups are mixed in a polymer chain. A hydrophilic phase formed from the fine phase separation in the proton conductive polymer is small enough to pass hydrated protons but not hydrated vanadium ions, which is size rejected (or blocked). In other words, the proton conductive polymer may be a size rejecter. Specifically, hydrated protons are much smaller than hydrated vanadium ions, and the hydrophilic phase is bigger than the hydrated protons, but smaller than the hydrated vanadium ions. Accordingly, the hydrated vanadium ions are selectively suppressed from transmission, while the hydrated protons are transmitted.

The proton conductive polymer separator may have a thickness in a range from 10 μm to 200 μm and specifically, from 10 μm to 50 μm. In one embodiment, when the separator has a thickness within the above range, the separator satisfies both low electrolyte resistance and low cross-over of an active material, and thus realizes a redox flow battery with high energy efficiency.

In addition, the separator may have a desired or ideal thickness depending on concentration of an active material. Specifically, in one embodiment, when a vanadium-based active material solution includes a vanadium-based active material in a concentration from 1 to 4 M, the separator should have a thickness in a range from 50 μm to 200 μm. In one embodiment, when a vanadium-based active material is included in a concentration of less than 1 M, the separator should have a thickness in a range from 10 μm or more and less than 50 μm.

As such, the separator including the proton conductive polymer has a small path for transmitting protons and size-rejected protons, and accordingly, may suppress self discharge and improve coulombic efficiency.

In another embodiment of the present invention, a redox flow battery is provided to include the aforementioned separator.

The redox flow battery according to one embodiment is illustrated in the drawing.

That is, the drawing is a schematic view illustrating a redox flow battery according to one embodiment.

Referring to the drawing, the redox flow battery 20 includes an electrode assembly including a separator 22, a positive electrode 24, and a negative electrode 26. Here, the separator 22 is positioned between the positive electrode 24 and the negative electrode 26. In addition, the redox flow battery 20 includes a positive electrode supplier 28 including a positive active material solution and configured to supply the positive active material solution to the positive electrode 24, and a negative electrode supplier 30 including a negative active material solution and configured to supply the negative active material solution to the negative electrode 26.

The positive active material solution stored in the positive electrode supplier 28 is transmitted to the positive electrode 24 through a positive active material inlet 31 via a first pump 51, and then moves back to the positive electrode supplier 28 through a positive active material outlet 41 when a redox reaction is complete. The negative active material stored in the negative electrode supplier 30 is also transmitted to the negative electrode 26 through a negative active material inlet 32 via a second pump 52, and then moves back to the negative electrode supplier 30 through a negative active material outlet 42 when a redox reaction is complete.

The positive and negative electrodes may each include a conductive substrate. In addition, the conductive substrate may further include a flow plate on one side, that is, on the side opposing the separator.

The conductive substrate may include carbon paper, carbon cloth, carbon felt, or metal cloth (porous film made of fiber-type metal or metal film formed on the surface of polymer fiber cloth), but is not limited thereto. In addition, the conductive substrate may be porous.

The flow plate may be formed of graphite. This flow plate may include a path.

The positive active material solution includes the positive active material and a solvent.

The positive active material may include a +4 to +5 vanadium-based compound (e.g., a +4 oxidation state to +5 oxidation vanadium-based compound), such as, for example, (VO₂)₂SO₄, VO(SO₄), or a combination thereof.

The solvent may include a sulfuric acid aqueous solution. The sulfuric acid aqueous solution includes sulfuric acid with a concentration in a range from 0.5M to 4M. In one embodiment, when the sulfuric acid aqueous solution has a concentration within the above range, the sulfuric acid aqueous solution has appropriate proton conductivity and maintains power performance and appropriate viscosity, and accordingly, does not decrease reaction speed of an active material.

The positive active material solution may have a concentration in a range from 1M to 10M (of the positive active material in the solution). In one embodiment, when the positive active material solution has a concentration within the above range, enough positive active material is included per unit volume to realize high energy density, and in addition, to appropriately maintain proper viscosity of the positive active material solution and to bring about excellent oxidation and reduction reaction speed, thereby accomplishing high power density.

The negative active material solution may include a negative active material and a solvent.

The negative active material may include a +2 to +3 vanadium-based compound (e.g., a +2 oxidation state to +3 oxidation state vanadium-based compound), such as, for example, VSO₄, V₂(SO₄)₃, or a combination thereof.

The solvent may include a sulfuric acid aqueous solution.

The negative active material solution may have a concentration in a range from 1M to 10 M (of the negative active material in the solution). In one embodiment, when the negative active material solution has a concentration within the above range, enough negative active material is included per unit volume to obtain high energy density, and also to maintain appropriate viscosity of the negative active material solution and to thus have excellent oxidation and reduction reaction speed, thereby accomplishing high power density.

Hereinafter, the embodiments are illustrated in more detail with reference to examples. However, the following are exemplary embodiments and are not limiting.

Furthermore, what is not described in this specification can be sufficiently understood by those who have knowledge in this field and will not be illustrated here.

Fabrication of Separator

### EXAMPLE 1

A film produced by using a proton conductive polymer (random copolymer) including a first repeating unit represented by the following Chemical Formula 2-1a and a second repeating unit represented by the following Chemical Formula 2-1b was used as a separator (a thickness of 100 μm).

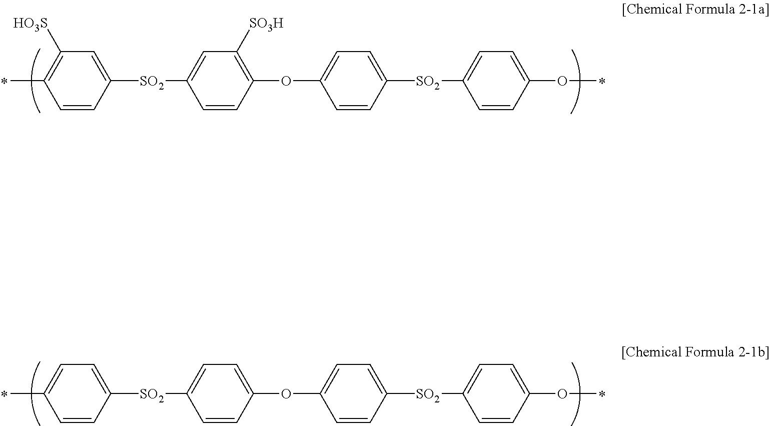

In Chemical Formulas 2-1a and 2-1b, the mole fraction (n) of the first repeating unit is 0.3 based on the total moles of the first and the second repeating unit and the mole fraction (m) of the second repeating unit is 0.7 based on the total moles of the first and the second repeating unit.

### EXAMPLE 2

A film produced by using a proton conductive polymer (random copolymer) including a first repeating unit represented by the following Chemical Formula 2-2a and a second repeating unit represented by the following Chemical Formula 2-2b was used as a separator (a thickness of 100 μm).

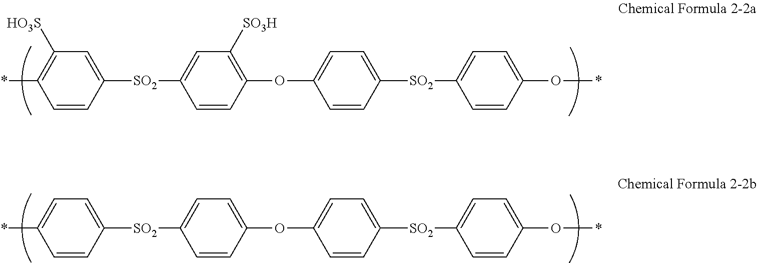

In Chemical Formulas 2-2a and 2-2b, the mole fraction (n) of the first repeating unit is0.5 based on the total moles of the first and the second repeating unit and the mole fraction (m) of the second repeating unit is 0.5 based on the total moles of the first and the second repeating unit.

### EXAMPLE 3

A film produced by using a proton conductive polymer (random copolymer) including a first repeating unit represented by the following Chemical Formula 2-3a and a second repeating unit represented by the following Chemical Formula 2-3b was used as a separator (a thickness of 100 μm).

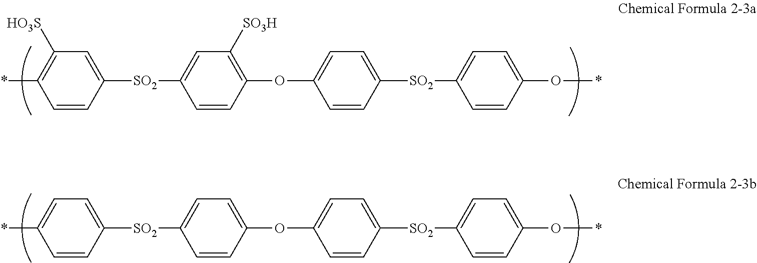

_{In Chemical Formulas} 2-3a and 2-3b, the mole fraction (n) of the first repeating unit is0.7 based on the total moles of the first and the second repeating unit and the mole fraction (m) of the second repeating unit is 0.3 based on the total moles of the first and the second repeating unit.

### EXAMPLE 4

A film produced by using a proton conductive polymer (random copolymer) including a first repeating unit represented by the following Chemical Formula 2-4a and a second repeating unit represented by the following Chemical Formula 2-4b was used as a separator (a thickness of 100 μm).

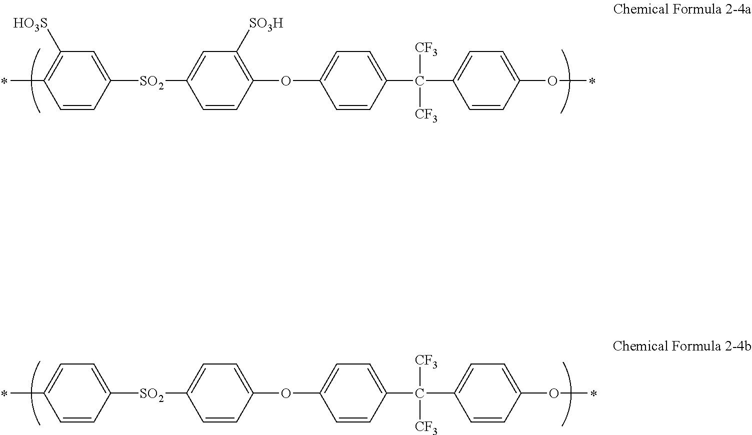

In Chemical Formulas 2-4a and 2-4b, the mole fraction (n) of the first repeating unit is 0.3 based on the total moles of the first and the second repeating unit, and the mole fraction (m) of the second repeating unit is 0.7 based on the total moles of the first and the second repeating unit.

### EXAMPLE 5

A film produced by using a proton conductive polymer (random copolymer) including a first repeating unit represented by the following Chemical Formula 2-5a and a second repeating unit represented by the following Chemical Formula 2-5b was used as a separator (a thickness of 100 μm).

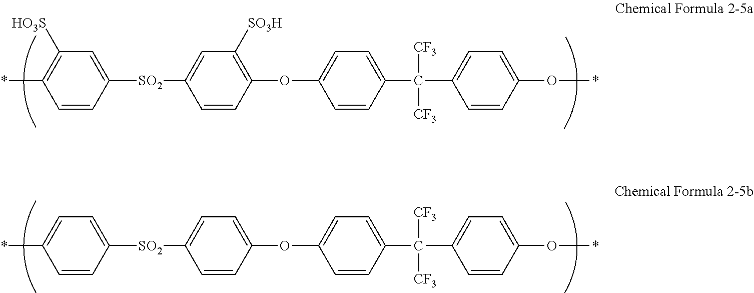

In Chemical Formulas 2-5a and 2-5b, the mole fraction (n) of the first repeating unit is 0.5 based on the total moles of the first and the second repeating unit and the mole fraction (m) of the second repeating unit is 0.5 based on the total moles of the first and the second repeating unit.

### EXAMPLE 6

A film produced by using a proton conductive polymer (random copolymer) including a first repeating unit represented by the following Chemical Formula 2-6a and a second repeating unit represented by the following Chemical Formula 2-6b was used as a separator (a thickness of 100 μm).

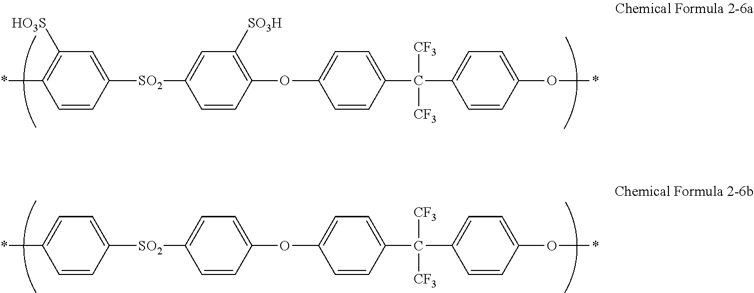

In Chemical Formulas 2-6a and 2-6b, the mole fraction (n) of the first repeating unit is 0.7 based on the total moles of the first and the second repeating unit and the mole fraction (m) of the second repeating unit is 0.3 based on the total moles of the first and the second repeating unit.

### EXAMPLE 7

A film produced by using a proton conductive polymer (random copolymer) including a first repeating unit represented by the following Chemical Formula 2-7a and a second repeating unit represented by the following Chemical Formula 2-7b was used as a separator (a thickness of 100 μm).

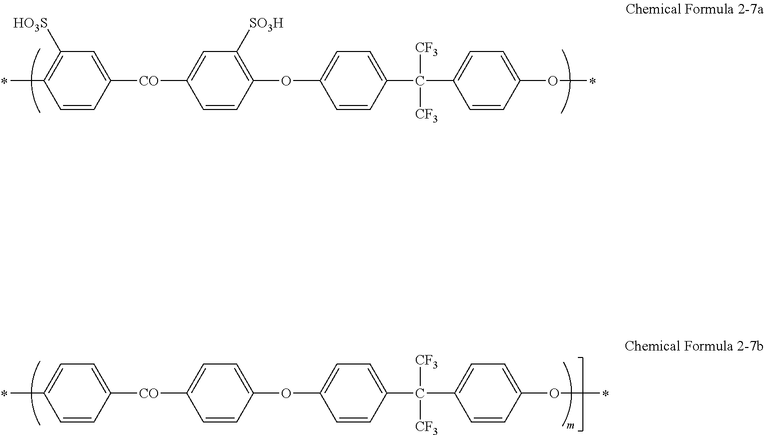

In Chemical Formulas 2-7a and 2-7b, the mole fraction (n) of the first repeating unit is 0.3 based on the total moles of the first and the second repeating unit and the mole fraction (m) of the second repeating unit is 0.7 based on the total moles of the first and the second repeating unit.

### EXAMPLE 8

A film produced by using a proton conductive polymer (random copolymer) including a first repeating unit represented by the following Chemical Formula 2-8a and a second repeating unit represented by the following Chemical Formula 2-8b was used as a separator (a thickness of 100 μm).

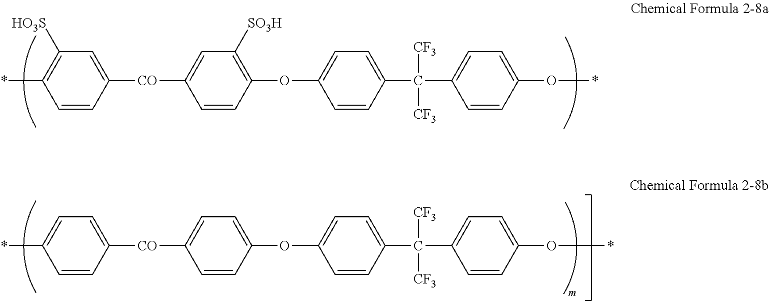

In Chemical Formulas 2-8a and 2-8b, the mole fraction (n) of the first repeating unit is 0.5 based on the total moles of the first and the second repeating unit and the mole fraction (m) of the second repeating unit is 0.5 based on the total moles of the first and the second repeating unit.

### EXAMPLE 9

A film produced by using a proton conductive polymer random copolymer) including a first repeating unit represented by the following Chemical Formula 2-9a and a second repeating unit represented by the following Chemical Formula 2-9b was used as a separator (a thickness of 100 μm).

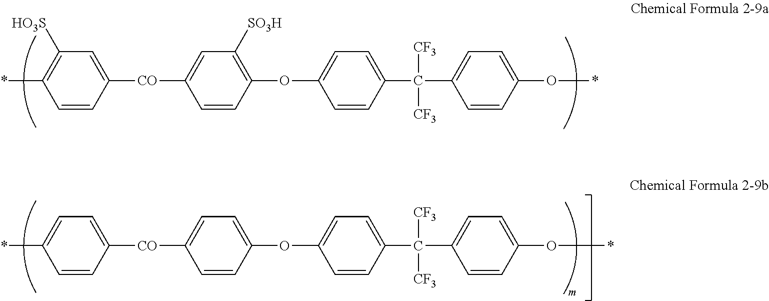

In Chemical Formulas 2-9a and 2-9b, the mole fraction (n) of the first repeating unit is 0.7 based on the total moles of the first and the second repeating unit and the mole fraction (m) of the second repeating unit is 0.3 based on the total moles of the first and the second repeating unit.

### COMPARATIVE EXAMPLE 1

Nation 117 (a thickness of 180 μm) made by Dupont Co. was used as a separator.

Fabrication of Redox Flow Battery

An electrode assembly was fabricated by positioning carbon felt positive and negative electrodes respectively on both sides of each of the separators according to Examples 1 to 9 and Comparative Example 1 and positioning a graphite flow plate on a side of each of the positive electrode and the negative electrode opposing the separator and then clamping them together. Herein, the cell area was 6 cm².

Then, a positive active material solution was prepared by dissolving 1.5M (VO₂)₂SO₄ in a 3M sulfuric acid aqueous solution, and a negative active material solution was prepared by dissolving 1.5M VSO₄ in a 3M sulfuric acid aqueous solution.

The electrode assembly, the positive active material solution, and the negative active material solution were used to fabricate a redox flow battery cell.

### EXPERIMENTAL EXAMPLE

### Measurement of Coulombic Efficiency and the Like of Redox Flow Battery

The redox flow battery cells according to Examples 1 to 9 and Comparative Example 1 were fabricated by implanting 30 ml of the positive and negative active material solutions into the electrode assembly, charged and discharged with current density of 50 mA/cm², and measured regarding film resistance, voltage efficiency, coulombic efficiency, and energy efficiency by the following methods.

(1) Film resistance: obtained by measuring impedance.

(2) Voltage efficiency: calculated according the following Equation 1.

Voltage efficiency (%)=(average voltage during discharge/average voltage during charge)×100 Equation 1

(3) Energy efficiency: calculated according to the following Equation 2.

Coulombic efficiency (%)=(discharge capacity/charge capacity)×100 Equation 2

Energy efficiency (%)=(voltage efficiency/100)×(coulombic efficiency/100)×100

These experiments were all performed at room temperature. The results are provided in the following Table 1.

TABLE 1

| | | Coulombic | | Energy |
|---|---|---|---|---|
| | Film resistance, | efficiency | Voltage | efficiency |
| | Ωcm² | (%) | efficiency (%) | (%) |
| Example 1 | 0.72 | 94.7 | 93.1 | 88.2 |
| Example 2 | 0.43 | 94.1 | 94.5 | 88.9 |
| Example 3 | 0.31 | 93.6 | 94.7 | 88.6 |
| Example 4 | 0.87 | 96.1 | 92.8 | 89.1 |
| Example 5 | 0.52 | 95.3 | 93.9 | 89.5 |
| Example 6 | 0.43 | 93.9 | 94.4 | 88.6 |
| Example 7 | 0.90 | 96.5 | 93.0 | 89.7 |
| Example 8 | 0.63 | 95.5 | 94.2 | 89.9 |
| Example 9 | 0.53 | 93.9 | 95.1 | 89.2 |
| Comparative | 1.20 | 91.2 | 92.3 | 84.2 |
| Example 1 | | | | |

Referring to Table 1, the proton conductive polymer separators according to Examples 1 to 9 were each thinner than the separator according to Comparative Example 1; but they suppressed transmission of vanadium ions and had low film resistance, and accordingly, had high voltage efficiency and high coulombic efficiency. Resultantly, the separators turned out to have high energy efficiency.

While this disclosure has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims, and equivalents thereof.

What is claimed is:

1. A separator for a redox flow battery comprising a proton conductive polymer comprising a first repeating unit represented by the following Chemical Formula 1a and a second repeating unit represented by the following Chemical Formula 1b: 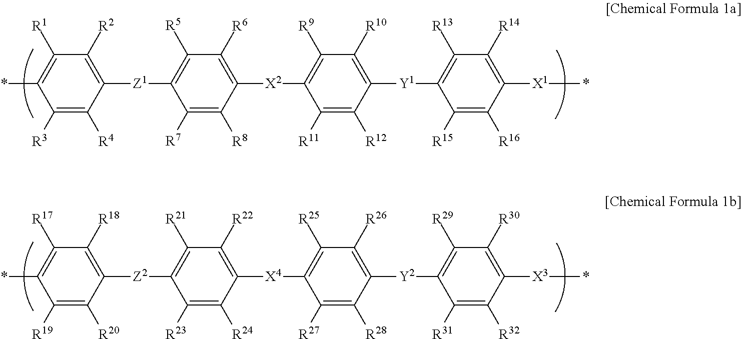
wherein,
X¹, X², X³, and X⁴ are the same or different and are each O or S,
Y¹ and Y² are the same or different and are each SO₂ or C(CF₂)₂,
Z¹ and Z² are the same or different and are each SO₂ or CO,
R¹ to R¹⁶ are the same or different and are each hydrogen, a halogen, a C1 to C10 alkyl group, a C1 to C10 halogen-substituted alkyl group, a sulfonic acid group, a phosphoric acid group, or a carboxylic acid group, provided that at least one of R¹ to R¹⁶ is a sulfonic acid group, a phosphoric acid group, or a carboxylic acid group,
R¹⁷ to R³² are the same or different and are each hydrogen, a halogen, a C1 to C10 alkyl group, or a C1 to C10 halogen-substituted alkyl group.

2. The separator for a redox flow battery of claim 1, wherein a mole fraction (n) of the first repeating unit represented by Chemical Formula la is 0.3≦n≦0.8 based on the total moles of the first and the second repeating unit, and
a mole fraction (m) of the second unit represented by Chemical Formula 1b is 0.2≦m≦0.7 based on the total moles of the first and the second repeating unit.

3. The separator for a redox flow battery of claim 1, wherein, in Chemical Formulas 1a, at least one of R¹ to R⁴ and at least one of R⁵ to R⁸ are each a sulfonic acid group, a phosphoric acid group, or a carboxylic acid group.

4. The separator for a redox flow battery of claim 2, wherein, 0.4≦n≦0.7 and 0.3≦m≦0.6.

5. The separator for a redox flow battery of claim 1, wherein the separator has a thickness in a range from 10 μm to 200 μm.

6. A redox flow battery comprising
an electrode assembly comprising the separator of claim 1, a positive electrode, and a negative electrode, the separator being between the positive electrode and the negative electrode;
a positive electrode supplier comprising a positive active material solution and configured to supply the positive active material solution to the positive electrode; and
a negative electrode supplier comprising a negative active material solution and configured to supply the negative active material solution to the negative electrode.

7. The redox flow battery of claim 6, wherein the positive active material solution comprises a positive active material and a solvent.

8. The redox flow battery of claim 7, wherein the positive active material comprises a +4 to +5 vanadium-based compound.

9. The redox flow battery of claim 7, wherein the positive active material comprises (VO₂)₂SO₄, VO(SO₄), or a combination thereof.

10. The redox flow battery of claim 7, wherein the solvent comprises a sulfuric acid aqueous solution.

11. The redox flow battery of claim 6, wherein the positive active material solution has a concentration in a range from 1M to 10M.

12. The redox flow battery of claim 6, wherein the negative active material solution comprises a negative active material and a solvent.

13. The redox flow battery of claim 12, wherein the negative active material comprises a +2 to +3 vanadium-based compound.

14. The redox flow battery of claim 12, wherein the negative active material comprises VSO₄, V₂(SO₄)₃, or a combination thereof.

15. The redox flow battery of claim 12, wherein the solvent comprises a sulfuric acid aqueous solution.

16. The redox flow battery of claim 12, wherein the negative active material solution has a concentration in a range from 1M to 10M.

17. A redox flow battery comprising
the separator of claim 1;
a positive electrode;
a negative electrode, the separator being between the positive electrode and the negative electrode;
a positive electrode supplier comprising a positive active material solution and configured to supply the positive active material solution to the positive electrode; and
a negative electrode supplier comprising a negative active material solution and configured to supply the negative active material solution to the negative electrode.

18. The redox flow battery of claim 17, wherein the separator has a thickness in a range from 10 μm to 200 μm.
